(19) United States
(12) Patent Application Publication
(10) Pub. No.: US 2025/0250189 A1
(43) Pub. Date: Aug. 7, 2025

(54) SLURRY TREATMENT OF PRODUCED WATER

(71) Applicant: ChampionX LLC, Sugar Land, TX (US)

(72) Inventors: Izabela Anita Owsik, College Station, TX (US); William Thomas Duttlinger, JR., Houston, TX (US)

(21) Appl. No.: 19/044,679

(22) Filed: Feb. 4, 2025

Related U.S. Application Data
(60) Provisional application No. 63/549,678, filed on Feb. 5, 2024.

(51) Int. Cl. C02F 5/08; B01J 20/10; B01J 20/28; C02F 101/32

(52) U.S. Cl. CPC C02F 5/08; B01J 20/103; B01J 20/28059; B01J 20/28061; B01J 20/28064; B01J 20/28066; C02F 2101/32

(57) ABSTRACT

Methods of treating a produced water having one or more water soluble organic compounds (WSO) dispersed therein include mixing the produced water with 1 ppm to 50,000 ppm by weight of an adsorbent particulate to form a slurry; and separating a purified produced water from the slurry, wherein the purified produced fluid includes a lower concentration of one or more WSO than the produced fluid, wherein WSO is the fraction of the dissolved and dispersed hexane extractable compounds in the produced water that does not flash off at 85° C., and adsorbs onto silica gel.

### BACKGROUND

Produced water is water trapped in underground formations that is brought to the surface during oil and gas exploration and production. In traditional oil and gas wells, produced water is brought to the surface along with oil or gas. In coal bed methane production, wells are drilled into coal seams, and the water located there is pumped to the surface in order to allow gas to release from the coal seams. Because the water has been in contact with the hydrocarbon-bearing formation for centuries, it includes some of the chemical compounds and materials of the formation, including the hydrocarbon itself. The physical and chemical properties of produced water vary considerably depending on the geographic location of the field, the geological formation from which it comes, and the type of hydrocarbon product being produced along with the water. Produced water further includes water injected into the formation, and can further include chemicals added to the formation during the drilling, production, and treatment processes.

Impurities in produced water include salts and other inorganic materials and compounds, as well as various hydrocarbon impurities classified as oils and greases. Industrially, produced water may be characterized by the amount of Total Oil and Grease (TOG), Total Petroleum Hydrocarbons (TPH) and/or Water Soluble Organics (WSO) dissolved or dispersed therein. TOG is defined as the total amount of hexane-extractable hydrocarbons in a produced water. TOG is calculated as a sum of TPH+WSO. TPH is the fraction of hydrocarbon compounds in a produced water that are extractable by n-hexane but not absorbed on silica; and WSO is defined as the fraction of the dissolved and dispersed hexane extractable material in a produced water that does not flash off at 85° C., and adsorbs onto silica gel.

Residual TOG in produced waters are a primary concern in the industry. In the Gulf of Mexico for example, TOG in produced water is limited to 29 mg/l average and 42 mg/l for excursions. Accordingly, most produced waters are treated in an attempt to remove TOG. Conventional produced water treatment systems use traditional water treatment chemistries that are effective to remove TPH, but have limited efficacy in removing WSO. In some cases, prior to separation of the produced water from the oil phase, the oil/produced water mixture is subjected to acid facilitated treatment to promote WSO dissolution into the oil phase. However, the resulting acidification of the produced water introduces additional potential for corrosion of equipment.

Because of the foregoing difficulties in removing WSO, produced waters including a high level of WSO are problematic from a regulatory standpoint because WSO adds to the TOG and may cause a produced water to surpass acceptable TOG levels. For example, in the Gulf of Mexico as mentioned above, where TOG in produced water is limited to 29 mg/l average, produced waters having an average concentration of WSO greater than 29 mg/l cannot be used to achieve regulatory discharge limits using conventional water treatment chemistries.

The cost of managing produced water is a significant factor overall in the profitability of oil and gas production. The total cost (ranging from less than 1 cent/bbl to more than $5/bbl) of produced water treatment includes but is not limited to constructing treatment and disposal facilities; operating those facilities, including material costs; management of residuals or byproducts resulting from the treatment of the produced water; and costs associated with permitting and monitoring treatment materials and processes. In some instances, the cost of managing produced water exceeds the value of the hydrocarbon produced from the well, justifying shutdown of production altogether.

Accordingly, there is an ongoing need in the industry for improved methods of removing or reducing WSO from produced waters. There is a further need for such methods to be implemented with ease, using existing equipment present in and near facilities for managing produced waters.

### SUMMARY

To address the foregoing needs, disclosed herein are compositions and methods for treating a produced water having one or more water soluble organics (WSO) dispersed therein. In embodiments, the methods comprise, consist essentially of, or consist of: mixing a produced water with 1 ppm to 50,000 ppm by weight of an adsorbent particulate to form a slurry; applying a flow of the slurry through a conduit; and separating a purified produced water from the flow of slurry, wherein the purified produced fluid includes a lower concentration of one or more WSO than the produced water, wherein WSO are defined as the fraction of the dissolved and polar dispersed hexane extractable compounds in the produced water that does not flash off at 85° C., and adsorbs onto silica gel. In embodiments, the methods include mixing the produced water with 100 ppm to 10,000 ppm by weight of the adsorbent particulate, or with 500 ppm to 5,000 ppm by weight of the adsorbent particulate.

In embodiments, the adsorbent particulate has a surface area of 100 m²/g or more, or 1000 m²/g or more. In embodiments, the adsorbent particulate has an average particle size of 1 nm to 500 μm. In embodiments, the adsorbent particulate is porous. In embodiments, the adsorbent, porous particulate is microporous, nanoporous, mesoporous, macroporous, or a combination of two or more thereof. In embodiments, the adsorbent particulate comprises one or more of: activated carbon, carbon nanotubes, expanded perlite, cellulose, diatomaceous earth, alumina, ultra-high surface area silica, or Halloysite nanotubes. In embodiments, the activated carbon is derived from one or more of coconut shell, orange peel, bamboo fiber, rice husk, sewage sludge, or bone.

In embodiments, the methods further include adding one or more corrosion inhibitors, one or more flocculants, one or more coagulants, one or more scale inhibitors, one or more biocides, one or more fluorescent compounds, one or more chemical indicators, one or more defoamers, one or more antifoulants, one or more antioxidants, one or more pH adjustment agents, or any combination thereof to the produced water and/or to the slurry. In embodiments, the methods include adding one or more additional particulates to the produced fluid and/or to the slurry. In embodiments, the one or more additional particulates include an organic polymer. In embodiments, the organic polymer comprises, consists essentially of, or consists of a cellulose, a crosslinked dextran, a divinyl benzene-styrene copolymer, or two or more of thereof.

In embodiments, the methods further include adding one or more corrosion inhibitors, one or more biocides, one or more scale inhibitors, one or more fluorescent compounds, one or more chemical indicators, one or more defoamers, one or more antifoulants, one or more antioxidants, one or more pH adjustment agents, or any combination thereof to the purified produced fluid.

In embodiments, the separating is filtering. In embodiments, the filtering is accomplished using a screen, a mesh, a nonwoven or woven thermoplastic mat, a nonwoven or woven metal mat, a paper, a woven or nonwoven fabric mat, a nonwoven or woven glass mat; a frit, a porous membrane, a perforated plate, a felted fabric, or a combination thereof. In embodiments, the filtering is microfiltering or ultrafiltering. In embodiments, the filtering is cross-flow filtering or dead-end filtering.

In embodiments, the separating is gravity-based separating or applying a central force to the slurry. In embodiments, a central force is applied to a slurry by a centrifuge or a hydrocyclone. In embodiments, the gravity-based separation is sedimentation or cross-current flow.

In embodiments, the separating is sparging the slurry, and collecting a froth.

Also disclosed herein is a slurry comprising, consisting essentially of, or consisting of 1 ppm to 50,000 ppm by weight of an adsorbent particulate dispersed in a produced fluid, wherein the produced fluid has one or more WSO dispersed therein; and wherein the slurry is disposed within a conduit of a well completion string. In embodiments, the slurry is flowing through the conduit. In embodiments, the slurry further includes one or more corrosion inhibitors, one or more flocculants, one or more coagulants, one or more scale inhibitors, one or more biocides, or any combination thereof; or one or more additional particulates comprising an organic polymer comprising, consisting essentially of, or consisting of a cellulose, a crosslinked dextran, a divinyl benzene-styrene copolymer, or two or more thereof.

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Definitions

As used herein, “particulate” refers to a discrete group or mass of particles characterized by a particle size.

As used herein, “particle size” refers to an average particle size, a median particle size, a mean particle size, or a particle size dispersity of an particulate, as specified or determined by context and further as such particle sizes are determined by a method of particle size analysis known by those of ordinary skill in the art of analyzing particles having dimensions of 1000 nm or less. Such methods include light scattering analysis and Coulter counter methods, for example. Unless specified otherwise, “particle size” generally refers to a volume-based average or method of measuring a volume-based average, further assuming spherical particles. When comparing two or more particulates, differences in median particle sizes and/or other particle size parameters are determined based on the respective individually determined median particle sizes and/or other specified parameters.

As used herein, the terms “WSO”, “water soluble organics”, or “water soluble organic compounds” are defined herein as the fraction of the dissolved and polar dispersed hexane extractable material in a produced water that does not flash off at 85° C., and adsorbs onto silica gel. WSO include but are not limited to benzene, toluene, ethylbenzene, and xylene (“BTEX”), phenols, and organic acids.

Unless otherwise determined by context, “dispersed” refers herein to any one or more solid or liquid compounds or particulates that are entrained, contained, incorporated, or encompassed within a produced water. Further as determined by context, a dispersed compound or particulate may further be characterized as one or more of dissolved, partly dissolved, miscible, partly miscible, aggregated, or coalesced in the produced water.

As used herein, “slurry” refers to a dispersion of a particulate in a fluid, wherein the mixture obtains fluid characteristics, that is, the slurry is capable of flowing, wherein the particulate flows with the fluid and does not become associated with an interface.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### Discussion

Disclosed herein are methods of treating a produced water having one or more water soluble organics (WSO) dispersed therein, wherein the treatment obtains a purified produced water having a reduced concentration of the one or more WSO. As defined herein, “WSO” refers to the fraction of the dissolved and dispersed hexane extractable material in a produced water that does not flash off at 85° C., and does adsorb onto silica gel. This definition is in accordance with the petroleum industry, which has identified WSO as a class of materials present in a produced water.

The methods herein comprise, consist essentially of, or consist of contacting a produced water with 1 ppm to 50,000 ppm by weight of one or more adsorbent particulates to form a slurry of the adsorbent particulate in the produced water; and separating a purified produced water from the slurry, wherein the purified produced water includes a lower concentration of one or more WSO compared to the produced water. As used herein, “slurry” means a dispersion of a particulate in a fluid, wherein the dispersion overall obtains fluid characteristics—that is, a slurry is capable of flowing, wherein the one or more particulates flow with the fluid and do not become associated with an interface.

In embodiments, the slurry is formed within, and/or is disposed within, one or more conduits. In embodiments, the one or more conduits are part of a well production string, or are fluidly connection to a well production stream. In embodiments, the one or more conduits comprise, consist essentially of, or consist of pipes and/or tubes. Conventionally, the one or more conduits contain and transport a flow of produced water toward one or more refining facilities, or toward one or more storage containments to await refining, toward one or more produced water treatment facilities, or within one or more produced water treatment facilities, or toward one or more disposal areas as selected by an operator. Any such conduits are “conduits of a well production string”, for purposes of the methods and compositions described herein.

In embodiments, the one or more conduits are part of one or more downstream water and/or hydrocarbon treatment, separation, or processing facilities; one or more upstream water and/or hydrocarbon treatment, separation, or processing facilities; one or more hydrogen production facilities; one or more oxidation processing facilities, one or more pyrolysis processing facilities; one or more municipal water treatment facilities; one or more industrial wastewater treatment, separation, or processing facilities; or any combination thereof.

The one or more adsorbent particulates present in the slurry are each characterized as having a surface area of at least 100 m²/g and a swelling differential of less than 10% in a produced water. In embodiments, the adsorbent particulate is porous. In embodiments, a porous adsorbent particulate is nanoporous, microporous, mesoporous, macroporous, or a combination of two or more of these, where nanoporous is defined as having an average pore diameter of 100 nm or less; microporous is defined as having an average pore diameter of less than 2 nm; mesoporous is defined as having an average pore diameter between 2 nm and 50 nm; and macroporous is defined as having an average pore diameter of greater than 50 nm.

Upon contacting the adsorbent particulate with the produced water, a slurry is formed. Upon forming the slurry, the adsorbent particulate adsorbs one or more WSO from the produced water. Then a WSO-laden particulate is separated from the slurry, leaving a purified produced water having a lower concentration of WSO than the produced water prior to contacting the adsorbent particulate.

Accordingly, separating a purified produced water from the slurry comprises, consists essentially of, or consists of separating a purified produced water from a WSO-laden particulate, wherein the WSO-laden particulate comprises, consists essentially of, or consists of the one or more adsorbent particulates having one or more WSO adsorbed thereto or therein, further wherein “adsorbed” in this context means that the one or more water soluble organic compounds remain associated with the adsorbent particulate during the separating.

Separating a WSO-laden particulate from the slurry obtains a purified produced water, wherein the purified produced water is characterized as having a reduced concentration of one or more WSO compared to the produced water source prior to forming the slurry, further wherein the “produced water source” refers to the actual produced water that is used to form the slurry.

In embodiments, each of the one or more adsorbent particulates have a surface area of at least 100 m²/g, and in embodiments more than 3000 m²/g, as determined by gas absorption methods. In embodiments, the one or more adsorbent particulates are capable of dispersing in produced water to form a slurry, wherein “slurry” in this context means that one or more particulates are suspended or dispersed in the produced water, wherein the suspension or dispersion overall obtains a fluid character (that is, the slurry is capable of flowing); further wherein the particulate does not dissolve in the produced water, and does not swell more than 10% by volume in the produced water. Such particulates are useful to scavenge WSO from a produced water.

Further, produced water combined with the one or more adsorbent particulates provides a slurry that is sufficiently stable to flow through one or more conduits of a well production string without loss of any of the particulate (whether or not WSO-laden). That is, the slurry obtains a stable flow within one or more conduits wherein neither one or more adsorbent particulates, nor one or more WSO-laden particulates “falls” out of the slurry to become associated with, or adhered to, one or more of the conduit surfaces. Accordingly, the one or more adsorbent particulates and the one or more WSO-laden particulates remain associated with the flow of fluid through the one or more conduits of a well production string.

Accordingly, we have found that it is possible to obtain in situ treatment of produced waters, that is, purification of a produced water to remove one or more WSOs therefrom while the produced water is flowing, for example within one or more conduits of a well production string; and wherein the treatment results in removal from the produced water of a portion or in some embodiments even substantially all of the WSOs present in the produced water. The in situ treatment is obtained by contacting one or more adsorbent particulates with a produced water to form a slurry; and then separating a WSO-laden particulate from the slurry to obtain a purified produced water. In embodiments, the in situ treatment further includes providing a flow of the slurry through one or more conduits, such as one or more conduits of a well production string; or one or more conduits of a produced water treatment facility.

Accordingly, formation of the slurry is suitably carried out at any point along a well production string or within a produced water treatment facility by adding an adsorbent particulate to a flow of produced water within a conduit present in the well production string or the produced water treatment facility, wherein the adsorbent particulate is characterized as having a surface area of at least 100 m²/g, and a swelling differential in produced water of 10% or less.

In embodiments, an adsorbent particulate has a surface area of at least 100 m²/g. In embodiments, an adsorbent particulate has a surface area of 1000 m²/g or more, or even 3000 m²/g or more. In embodiments an adsorbent particulate has a surface area of 100 m²/g to 5000 m²/g, for example 100 m²/g to 3000 m²/g, or 100 m²/g to 2000 m²/g, or 100 m²/g to 1000 m²/g, or 100 m²/g to 500 m²/g, or 500 m²/g to 5000 m²/g, or 1000 m²/g to 5000 m²/g, or 2000 m²/g to 5000 m²/g, or 3000 m²/g to 5000 m²/g, or 4000 m²/g to 5000 m²/g, or 100 m²/g to 200 m²/g, or 200 m²/g to 300 m²/g, or 300 m²/g to 400 m²/g, or 400 m²/g to 500 m²/g, or 500 m²/g to 600 m²/g, or 600 m²/g to 700 m²/g, or 700 m²/g to 800 m²/g, or 800 m²/g to 900 m²/g, or 900 m²/g to 1000 m²/g, or 1000 m²/g to 1200 m²/g, or 1200 m²/g to 1400 m²/g, or 1400 m²/g to 1600 m²/g, or 1600 m²/g to 1800 m²/g, or 1800 m²/g to 2000 m²/g, or 2000 m²/g to 2200 m²/g, or 2200 m²/g to 2400 m²/g, or 2400 m²/g to 2600 m²/g, or 2600 m²/g to 2800 m²/g, or 2800 m²/g to 3000 m²/g, or 3000 m²/g to 3200 m²/g, or 3200 m²/g to 3400 m²/g, or 3400 m²/g to 3600 m²/g, or 3600 m²/g to 3800 m²/g, or 3800 m²/g to 4000 m²/g, or 4000 m²/g to 4200 m²/g, or 4200 m²/g to 4400 m²/g, or 4400 m²/g to 4600 m²/g, or 4600 m²/g to 4800 m²/g, or 4800 m²/g to 5000 m²/g. In embodiments, higher surface area leads to a higher adsorption volume capacity per unit of weight of an adsorbent particulate—that is, a higher operational capacity—by providing more surface area for interaction with one or more WSOs. In embodiments, higher surface area correlates to a higher rate of adsorption of one or more WSOs from one or more produced waters.

In embodiments, an adsorbent particulate has an average particle size of 1 nm to 5 mm, as determined by laser light scattering, by image processing analysis, or by wet or dry sieve analysis such as vibratory sieving, air jet sieving, horizontal sieving, or tap sieving. In embodiments where an adsorbent particulate has an average particle size between 1 nm and 1000 nm, light scattering methods are used to determine an average particle size thereof. Accordingly, in embodiments, an adsorbent particulate has an average particle size of 1 nm to 5 mm, or 5 nm to 5 mm, or 10 nm to 5 mm, or 20 nm to 5 mm, or 30 nm to 5 mm, or 40 nm to 5 mm, or 50 nm to 5 mm, or 70 nm to 5 mm, or 100 nm to 5 mm, or 200 nm to 5 mm, or 300 nm to 5 mm, or 400 nm to 5 mm, or 500 nm to 5 mm, or 600 nm to 5 mm, or 700 nm to 5 mm, or 800 nm to 5 mm, or 900 nm to 5 mm, or 1000 nm (1 μm) to 5 mm, or 2 μm to 5 mm, or 3 μm to 5 mm, or 4 μm to 5 mm, or 5 μm to 5 mm, or 6 μm to 5 mm, or 7 μm to 5 mm, or 8 μm to 5 mm, or 9 μm to 5 mm, or 10 μm to 5 mm, or 20 μm to 5 mm, or 30 μm to 5 mm, or 40 μm to 5 mm, or 50 μm to 5 mm, or 60 μm to 5 mm, or 70 μm to 5 mm, or 80 μm to 5 mm, or 90 μm to 5 mm, or 100 μm to 5 mm, or 200 μm to 5 mm, or 300 μm to 5 mm, or 400 μm to 5 mm, or 500 μm to 5 mm, or 600 μm to 5 mm, or 700 μm to 5 mm, or 800 μm to 5 mm, or 900 μm to 5 mm, or 1000 μm (1 mm) to 5 mm, or 2 mm to 5 mm, or 3 mm to 5 mm, or 4 mm to 5 mm, or 1 nm to 4 mm, or 1 nm to 3 mm, or 1 nm to 2 mm, or 1 nm to 1 mm, or 1 nm to 900 μm, or 1 nm to 800 μm, or 1 nm to 700 μm, or 1 nm to 600 μm, or 1 nm to 500 μm, or 1 nm to 400 μm, or 1 nm to 300 μm, or 1 nm to 200 μm, or 1 nm to 100 μm, or 1 nm to 10 μm, or 1 nm to 9 μm, or 1 nm to 8 μm, or 1 nm to 7 μm, or 1 nm to 6 μm, or 1 nm to 5 μm, or 1 nm to 4 μm, or 1 nm to 3 μm, or 1 nm to 2 μm, or 1 nm to 1 μm, or 1 nm to 900 nm, or 1 nm to 800 nm, or 1 nm to 700 nm, or 1 nm to 600 nm, or 1 nm to 500 nm, or 1 nm to 400 nm, or 1 nm to 300 nm, or 1 nm to 200 nm, or 1 nm to 100 nm, or 1 nm to 90 nm, or 1 nm to 80 nm, or 1 nm to 70 nm, or 1 nm to 60 nm, or 1 nm to 50 nm, or 1 nm to 40 nm, or 1 nm to 30 nm, or 1 nm to 20 nm, or 1 nm to 10 nm, or 1 nm to 5 nm, or 5 nm to 10 nm, or 10 nm to 20 nm, or 20 nm to 30 nm, or 30 nm to 40 nm, or 40 nm to 50 nm, or 50 nm to 60 nm, or 60 nm to 70 nm, or 70 nm to 80 nm, or 80 nm to 90 nm, or 90 nm to 100 nm, or 100 nm to 200 nm, or 200 nm to 300 nm, or 300 nm to 400 nm, or 400 nm to 500 nm, or 500 nm to 600 nm, or 600 nm to 700 nm, or 700 nm to 800 nm, or 800 nm to 900 nm, or 900 nm to 1 μm, or 1μ m to 2μ, or 2μ m to 3 μm, or 3μ m to 4μ, or 4μ m to 5μ m, or 5 μm to 6 μm, or 6 μm to 7 μm, or 7 μm to 8 μm, or 8 μm to 9 μm, or 9 μm to 10 μm, or 10 μm to 20 μm, or 20 μm to 30 μm, or 30 μm to 40 μm, or 40 μm to 50 μm, or 50 μm to 60 μm, or 60 μm to 70 μm, or 70 μm to 80 μm, or 80 μm to 90 μm, or 90 μm to 100 μm, or 100 μm to 200 μm, or 200 μm to 300 μm, or 300 μm to 400 μm, or 400 μm to 500 μm, or 500 μm to 600 μm, or 600 μm to 700 μm, or 700 μm to 800 μm, or 800 μm to 900 μm, or 900 μm to 1 mm, or 1 mm to 1.5 mm, or 1.5 mm to 2 mm, or 2 mm to 2.5 mm, or 2.5 mm to 3 mm, or 3 mm to 3.5 mm, or 3.5 mm to 4 mm, or 4 mm to 4.5 mm, or 4.5 mm to 5 mm. In embodiments, smaller particle size facilitates faster adsorption of adsorbates, since smaller particles have greater surface area per unit of weight of the particulate. In embodiments where an adsorbent particulate is nonporous, the particle size is inversely related to the surface area of the particles, wherein a smaller particle size/higher surface area leads to a higher adsorption volume capacity per unit of weight of the adsorbent (operational capacity), by providing more surface area for interaction with one or more WSOs. In embodiments, smaller particle size correlates to a higher operational capacity for adsorption of one or more WSO. In embodiments, smaller particle size also correlates to a higher rate of adsorption of one or more WSO.

In embodiments, the one or more adsorbent particulates have a low swelling differential in a produced water; that is, the adsorbent particulates have a swelling differential of 10% or less in a produced water. Accordingly, when immersed in a produced water, an adsorbent particulate swells to a volume that is no more than 10% greater than the initial volume of the adsorbent particulate, based on the outer dimensions of the particles. Stated differently, a suitable adsorbent particulate having an initial volume of 1 nanoliter (as calculated by the outer dimensions of said adsorbent particulate) will obtain a volume of no more than 1.1 nanoliter when immersed in a produced water. In embodiments, the swelling differential of the adsorbent particulate is 0, or is substantially 0 in a produced water.

In embodiments, the swelling differential of one or more adsorbent particulates is between 0 and 10% in a produced water, such as 0.1% to 10%, or 0.5% to 10%, or 1% to 10%, or 2% to 10%, or 3% to 10%, or 4% to 10%, or 5% to 10%, or 6% to 10%, or 7% to 10%, or 8% to 10%, or 9% to 10%, or 0 to 9%, or 0 to 8%, or 0 to 7%, or 0 to 6%, or 0 to 5%, or 0 to 4%, or 0 to 3%, or 0 to 2%, or 0 to 1%, or 0 to 0.5%, or 0 to 0.1%, or 0.1% to 0.5%, or 0.5% to 1%, or 1% to 2%, or 2% to 3%, or 3% to 4%, or 4% to 5%, or 5% to 6%, or 6% to 7%, or 7% to 8%, or 8% to 9%, or about 0.1%, or less than 0.1%, or about 0.5%, or about 1%, or about 2%, or about 3%, or about 4%, or about 5%, or about 6%, or about 7%, or about 8%, or about 9%, or about 10% in a produced water. In embodiments, an adsorbent particulate having a low swelling differential increases the efficiency and process reproducibility of the produced water treatment processes described herein, and further enables a slurry of the adsorbent particulate and/or adsorbate-laden particulate in a produced water to maintain fluid characteristics, ensuring that the slurry is able to flow through one or more conduits. Operationally, due to the low swelling differential of the adsorbent particulates, the slurries described herein are able to flow through the restricted volume of an annular conduit present in one or more well production strings or produced water treatment facilities. In embodiments, the slurries obtain a stable flow, wherein all or substantially all of the adsorbent particulate and/or the WSO-laden particulate is transported through the conduit as a slurry, and no precipitate or residue attributable to the adsorbent particulate and/or the WSO-laden particulate is observed in association with a surface of the conduit.

In some embodiments, one or more of the adsorbent particulates are porous. In embodiments, an adsorbent particulate is nanoporous, microporous, mesoporous, macroporous, or a combination of two or more of these. Porosity of a particulate is related to surface area, wherein higher porosity obtains more surface area available for interaction with one or more adsorbates; however, the pore size must also be of a sufficient size to accommodate a particular target molecule in order for the higher surface area to translate to increased adsorption of the target molecule. Accordingly, pore diameter of a porous adsorbent particulate impacts the degree of partitioning and WSO adsorption in the purification processes described herein. Accordingly, in embodiments, higher porosity of an adsorbent particulate will lead to higher operational capacity for adsorption of one or more WSO.

Examples of porous adsorbent particulates useful in the purification processes described herein include molecular sieves, activated carbon (activated charcoal), expanded perlite, zeolites, crosslinked polymer beads, and ultra-high surface area (UHSA) silica.

In embodiments a surface of an adsorbent particulate is hydrophobic; in other embodiments a surface of an adsorbent particulate is hydrophilic; in still other embodiments an adsorbent particulate surface has both hydrophobic and hydrophilic portions. More-hydrophobic adsorbent surfaces may participate in the adsorption of less-polar WSOs from the aqueous environment of the produced water, wherein such participation arises from the tendency of water to exclude non-polar molecules. Accordingly, more-hydrophilic adsorbent surfaces may participate in the adsorption of more-polar groups or molecules from the aqueous environment of a produced water. Since the WSO present in a produced water can include compounds having both low solubility in water (0.1 g/L) as well as compounds that are miscible with water, it is advantageous in some embodiments to employ a mixture of two or more adsorbent particulates having different hydrophobic/hydrophilic surface characteristics.

In embodiments, the adsorbent particulate comprises, consists essentially of, or consists of one or more of: an activated carbon particulate, a carbon nanotube particulate, a Halloysite nanotube particulate, an expanded perlite particulate, a cellulose particulate, a diatomaceous earth particulate, an aluminum particulate, a particulate comprising, consisting essentially of, or consisting of crosslinked polymer beads, an ultra-high surface area silica, a nanoclay, a natural or synthetic zeolite, or a molecular sieve (a type of zeolite).

In embodiments, the adsorbent particulate is a mixture of two or more different adsorbent particulates that are selected from the foregoing, in any proportion, such as between 1000:1 and 1:1000 for a combination of any two different adsorbent particulates. In this context, “different” means that two particulates have one or more differences in physicochemical properties that may include but are not limited to: chemical composition, surface chemistry, particle size, porosity (porous vs. non-porous), pore size, pore diameter, pore volume, particle size, and/or surface area. Accordingly, in an exemplary embodiment, the adsorbent particulate is a mixture, in a proportion between 1000:1 and 1:1000 by weight, of two different adsorbent particulates, such as a mixture of an activated carbon particulate with a crosslinked organic polymer particulate; or a mixture of an aluminum particulate and an expanded perlite particulate; or some other such mixture. Other such mixtures, including mixtures with three, four, five, or even more different adsorbent particulate components, are readily envisioned for the purpose of tailoring the treatment methods described herein to ensure adsorption of targeted WSO present in a specific produced water source.

In embodiments, the adsorbent particulate comprises, consists essentially of, or consists of one or more activated carbon particulates derived from one or more of: coconut shell, orange peel, bamboo fiber, rice husk, sewage sludge, or bone. Activated carbon particulates are well known to those of skill in the art and are commercially available from a variety of sources. Activated carbon particulates are available in a wide range of average particle sizes and porosities. In embodiments, the activated carbon particulate has a surface area of at least 500 m²/g, often 1000 m²/g or greater, or 2000 m²/g or greater, or even 3000 m²/g or greater. In embodiments, an activated carbon particulate is macroporous, nanoporous, microporous, or mesoporous. In embodiments, the activated carbon particulate is a mixture of two or more activated carbon particulates differing in one or more properties related to surface area, pore size, or average particle size.

In embodiments, the adsorbent particulate comprises, consists essentially of, or consists of alumina. In embodiments, an adsorbent alumina particulate comprises one or more colloidal aluminas, one or more alumina-coated colloidal silicas, one or more porous alumina particulates, or any combination thereof. In embodiments, a colloidal alumina particulate has an average particle size of about 5 nm to 200 nm. In embodiments, an alumina-coated colloidal silica particulate has an average particle size of about 5 nm to 1000 nm. Alumina-coated silica particulates are available from CD Bioparticles of Shirley, NY; available under the trade name LEVASIL® from Nouryon of Houston, TX; or by synthesis using the techniques set forth in Jin et al., Colloids and Surfaces A: Physicochemical and Engineering Aspects Volume 441, pp. 170-177 (2014) or Chen et al., Ceramics International Volume 46, Issue 1, pp. 196-203 (2020). In embodiments, a porous alumina particulate is obtained by collecting a surface layer of anodized of aluminum, which obtains a porous structure, as described in Rheima et al., Case Studies in Chemical and Environmental Engineering Volume 8, p. 100428 (2023).

In embodiments, the adsorbent particulate comprises a mixture of two or more different alumina particulates, that is, alumina particulates having different particle sizes, mixtures of particulates consisting essentially of alumina with alumina-coated silica particulates; mixtures of porous alumina particulates with colloidal alumina particulates, or another mixture of two or more different alumina particulates.

In embodiments, the adsorbent particulate comprises, consists essentially of, or consists of an expanded perlite. In embodiments, a suitable expanded perlite has a surface area of at least 100 m²/g, often 100-200 m²/g (unexpanded perlite has a reported surface area of 1-5 m²/g). And ultra-high surface area silica, formed by pyrolysis of perlite, has a surface area of at least 700 m²/g.

In embodiments, the adsorbent particulate comprises, consists essentially of, or consists of one or more crosslinked synthetic polymers, such as a divinyl benzene (DVB) polymer or copolymer thereof with styrene, a crosslinked acrylate or methacrylate polymer or copolymer, a crosslinked hydroxylated acrylate or methacrylate polymer or copolymer, a crosslinked polyacrylamide. Crosslinked synthetic polymers are commercially available as products of varying chemistries, particle sizes, surface areas, average porosities, and pore sizes. Examples of commercially available crosslinked synthetic polymers include those available from the DuPont™ Company of Wilmington, Delaware, USA under the trade name AmberLite™ XAD™. For example, AmberLite™ XAD™ 16N is a crosslinked DVB adsorbent resin having an average surface area of about 800 m²/g, and a mean pore size of about 15 nm.

In embodiments, the adsorbent particulate comprises, consists essentially of, or consists of a nanoclay. Nanoclays are layered mineral silicates (phyllosilicates) that vary according to the chemical composition and morphology. Suitable nanoclay particulates include talc (Mg₃[Si₄O₁₀(OH)₂]), vermiculite (similar to talc but including additional layers of water molecules), mica (KAl₂[AlSi₃O₁₀(OH)₂]), kaolin (Al₂[Si₂O₅(OH)₄]), montmorillonite (Mg_{0.33}Al_{1.67}[Si₄O₁₀(OH)₂] (Ca, Na)ₓ (H₂O)ₙ), serpentine (Mg₃[Si₂O₅(OH)₄]) and sepiolite (Mg₄[Si₆O₁₅](OH)₂ 4H₂O) as well as more complex structures such as chlorite. In embodiments, the adsorbent particulate is Halloysite nanotube, (Al₂Si₂O₅(OH)₄·2H₂O) a layered nanotube that is chemically similar to kaolin.

Since they are naturally sourced, clay particulates, including nanoclays, have variable and/or irregular dimensions. For example, the length of a halloysite nanotube cylinder ranges from 10 nanometers (nm) to 10 microns (μm), most often about 100 nm to about 2 μm, while the inner surface diameter (that is, the lumen diameter) is 5 nm to 150 nm, often about 15 nm, and the outer surface diameter is dictated by the number of layers, wherein one layer is reported by various sources to be 7 Å thick.

In embodiments, the adsorbent particulate comprises, consists essentially of, or consists of a natural or synthetic zeolite, or molecular sieves. Zeolites are hydrated metal aluminosilicate compounds with well-defined crystalline structures. Molecular sieves are porous silicate or silicoaluminate particles, most often a type of synthetic or a natural zeolite, that operates to separate particles of molecular dimension.

In embodiments in accordance with the foregoing adsorbent particulates, methods of treating a produced water having one or more of WSO dispersed or dissolved therein include contacting the produced water with 1 ppm to 50,000 ppm by weight of one or more adsorbent particulates to form a slurry of the particulate in the produced water; and separating a purified produced water from the slurry, wherein the purified produced water includes a lower concentration of one or more of WSO compared to the produced water. In embodiments, the contacting includes mixing the produced water with 1 ppm to 50,000 ppm by weight of the adsorbent particulate, for example 100 ppm to 100,000 ppm, or 500 ppm to 5000 ppm, or 10 ppm to 50,000 ppm, or 100 ppm to 50,000 ppm, or 1000 ppm to 50,000 ppm, or 5000 ppm to 50,000 ppm, or 10,000 ppm to 50,000 ppm, or 1 ppm to 10,000 ppm, or 1 ppm to 1000 ppm, or 1 ppm to 100 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 600 ppm to 700 ppm, or 700 ppm to 800 ppm, or 800 ppm to 900 ppm, or 900 ppm to 1000 ppm, or 1000 ppm to 2000 ppm, or 2000 ppm to 3000 ppm, or 3000 ppm to 4000 ppm, or 4000 ppm to 5000 ppm, or 5000 ppm to 6000 ppm, or 6000 ppm to 7000 ppm, or 7000 ppm to 8000 ppm, or 8000 ppm to 9000 ppm, or 9000 ppm to 10,000 ppm, or 10,000 ppm to 15,000 ppm, or 15,000 ppm to 20,000 ppm, or 20,000 ppm to 25,000 ppm, or 25,000 ppm to 30,000 ppm, or 30,000 ppm to 35,000 ppm, or 35,000 ppm to 40,000 ppm, or 40,000 ppm to 45,000 ppm, or 45,000 ppm to 50,000 ppm by weight of the adsorbent particulate contacted with, or mixed with the produced water.

In embodiments, the contacting of one or more adsorbent particulates with a produced water having one or more WSO dispersed therein is accomplished by admixing the one or more adsorbent particulates with the produced water by direct addition of e.g. a adsorbent particulate dry powder to a conduit carrying the produced water having one or more WSO dispersed therein. In other embodiments, the adsorbent particulate is combined with an amount of water, a water miscible solvent, or a mixture thereof prior to contacting the combination with a produced water having one or more WSO dispersed therein. In some such embodiments, the adsorbent particulate is mixed in-line with an amount of the produced water by separating a side stream of the produced water from the main flow thereof, contacting the side stream with a selected amount of the adsorbent particulate; and rejoining the side stream with the main flow of produced water having one or more WSO dispersed therein. Use of any of these methods, as well as others, results in formation of a slurry of adsorbent particulate in the produced water, further wherein the slurry is disposed within a conduit of a well production string or a produced water treatment facility.

In embodiments, the methods herein further include flowing the slurry through one or more conduits of the well completion string or the produced water treatment facility, that is, allowing the slurry components to remain contacted while being conducted through the well completion string or the produced water treatment facility. In such embodiments, the slurry flow proceeds through the one or more conduits of the well completion string until reaching a separation apparatus. The flow rate of the slurry is selected by the operator.

In some embodiments, the methods herein further include adding one or more additional particles, corrosion inhibitors, one or more flocculants, one or more coagulants, one or more scale inhibitors, one or more biocides, or any combination thereof to the slurry and/or to the produced water used to form the slurry. The amount of the one or more additional particles, one or more flocculants, one or more coagulants, one or more scale inhibitors, and/or one or more biocides added to the slurry and/or to the produced water used to form the slurry are suitably determined based on conventional knowledge regarding the operation of well completion strings and produced water treatment facilities. In embodiments, the one or more additional particulates are selected from cellulose particulates, crosslinked dextran particulates, and particulates formed from copolymers of divinylbenzene with styrene.

In some embodiments, or more corrosion inhibitors, one or more biocides, one or more scale inhibitors, or any combination thereof are added to the purified produced water.

In embodiments, separating a slurry into a purified produced water and a WSO-laden particulate is accomplished by subjecting the slurry to one or more filtration steps, one or more sedimentation steps, one or more countercurrent flow steps, one or more hydrocyclone steps, one or more centrifuge steps, one or more frothing steps; or a combination of two or more such steps in any order. The separating obtains partitioning of a slurry into a purified produced water portion and a WSO-laden particulate portion.

In embodiments, a purified produced water portion excludes or substantially excludes the adsorbent particulate and also excludes or substantially excludes WSO-laden particulate. In embodiments, the WSO-laden particulate portion consists essentially of an WSO-laden particulate, while in other embodiments the WSO-laden particulate portion comprises or consists essentially of the WSO-laden particulate and one or more of: adsorbent particulate (not WSO-laden), produced water, purified produced water.

In embodiments, separating a slurry into a purified produced water and a WSO-laden particulate is accomplished by filtration. In embodiments, the slurry is filtered by causing the slurry to pass through a filtration medium. Filtering the slurry obtains a filtrate and a residue, wherein the filtrate comprises, consists essentially of, or consists of a purified produced water; and the residue comprises, consists essentially of, or consists of an adsorbate-laden particulate. In embodiments, the filtration medium comprises, consists essentially of, or consists of one or more of a screen, a mesh, a nonwoven or woven thermoplastic mat, a nonwoven or woven metal mat, a woven or nonwoven fabric mat, a nonwoven or woven glass mat, a paper, a frit, a porous membrane, a perforated plate, or a felted fabric. In embodiments the filtering is microfiltering or ultrafiltering. In embodiments, the filtering is cross-flow filtering or dead-end filtering. In embodiments, the filtration is carried out in a single step; in other embodiments, multiple filtration steps are carried out to further purify the produced water.

In embodiments, separating a slurry into a purified produced water and a WSO-laden particulate is accomplished by use of a gravitational force. In embodiments, a gravitational separation is a continuous process; in other embodiments, the gravitational separation is a batch process. In some embodiments, the gravitational force is an ambient gravitational force, that is, a force of about 1 g (9.8 meters per second per second). Suitable ambient gravitational methods of separation include sedimentation, also referred to as settling; and countercurrent flow.

In embodiments, suitable sedimentation methods include applying the slurry to a settler or a sedimentation tank, and allowing the slurry to stand for a period of time. In embodiments, the slurry separates under gravitational force to obtain an upper region or layer comprising, consisting essentially of, or consisting of a purified produced water; and a bottom region or layer comprising a WSO-laden particulate.

In embodiments, ambient gravitational separation is accomplished by applying the slurry to a countercurrent flow. In such embodiments, the slurry is separated during the countercurrent flow to result in an underflow and an overflow, wherein the overflow comprises, consists essentially of, or consists of a purified produced water; and the underflow comprises a WSO-laden particulate.

In embodiments, separating a slurry is accomplished by applying a central force to the slurry. A central force is a force in excess of gravity, that is, >1 g. In some such embodiments, the central force is applied using a hydrocyclone or a centrifuge. In embodiments, the central force applied to the slurry is about 1.1 g to 1000 g. Applying a central force to a slurry within a hydrocyclone obtains an underflow and an overflow. In embodiments, the overflow comprises, consists essentially of, or consists of a purified produced water; and the underflow comprises a WSO-laden particulate. In embodiments, applying a central force to the slurry is applying a central force of about 1 g to 2000 g to the slurry, for example about 1 g to 1500 g, or about 1 g to 1000 g, or about 1 g to 800 g, or about 1 g to 600 g, or about 1 g to 500 g, or about 1 g to 400 g, or about 1 g to 300 g, or about 1 g to 200 g, or about 1 g to 100 g, or about 1 g to 80 g, or about 1 g to 60 g, or about 1 g to 40 g, or about 1 g to 20 g, or about 1 g to 10 g, or about 2 g to 1000 g, or about 4 g to 1000 g, or about 6 g to 1000 g, or about 8 g to 1000 g, or about 10 g to 1000 g, or about 2 g to 100 g, or about 4 g to 100 g, or about 6 g to 100 g, or about 8 g to 100 g, or about 10 g to 100 g to the slurry.

Applying a central force to the slurry within a centrifuge obtains a supernatant (liquid) and a pellet (compacted solid material, usually with some associated liquid). In embodiments, the supernatant comprises, consists essentially of, or consists of a purified produced water; and the pellet comprises, consists essentially of, or consists of a WSO-laden particulate.

The amount of time required for gravitational separation depends on the amount of gravitational force applied to the slurry in addition to the amount and type(s) of particulate(s) in the slurry, further in consideration of other factors such as the temperature of the slurry. In embodiments, the amount of time required to achieve ambient gravitational separation is about 1 second to 7 days; or about 1 second to about 4 days, or about 1 second to 2 days; or about 1 second to 1 day; or about 1 second to 12 hours; or about 1 second to 6 hours; or about 1 second to 3 hours; or about 1 minute to 7 days, or about 5 minutes to 7 days; or about 1 hour to 7 days; or about 3 hours to 7 days; or about 6 hours to 7 days; or about 12 hours to 7 days; or about 1 day to 7 days; or about 1 minute to 1 day, or about 10 minutes to 1 day, or about 30 minutes to 1 day, or about 1 hour to 1 day, or about 1 minute to 12 hours, or about 1 minute to 6 hours, or about 1 minute to 3 hours, or about 10 minutes to 1 day, or about 10 minutes to 12 hours, or about 10 minutes to 6 hours, or about 10 minutes to 3 hours. In some embodiments where the ambient gravitational separation takes hours or days as a batch process, the ambient gravitational separation is a continuous process for increased efficiency, as is understood by one of ordinary skill in the art of solid-liquid separations.

In embodiments, separating a slurry into a purified produced water and a WSO-laden particulate is accomplished by subjecting the slurry to one or more frothing steps. In embodiments, frothing is accomplished by sparging the slurry with a gas, allowing the bubbles to float to the surface of the sparged slurry, and collecting the bubbles, or “froth” from the sparged slurry. In some embodiments the sparging gas is air; in other embodiments the sparging gas is nitrogen gas or another gas. Because the gas is more hydrophobic than the surrounding water phase, compounds present in the water that are hydrophobic tend to adsorb preferentially to the water-gas interface of the bubbles. Similarly, particles can adsorb to the bubbles, where they form bubble-particle aggregates. As long as the aggregates have a lower density than the surrounding water phase, the aggregates are carried to the surface along with the bubbles, where they are collected by one or more methods well known to those of skill in the art of froth separation, such as skimming, or by collecting an overflow from the sparging vessel. Accordingly, sparging a slurry of WSO-laden particulate obtains a froth and a purified produced water. In embodiments, the froth comprises, consists essentially of, or consists of a WSO-laden particulate.

In embodiments, a purified produced water includes a lower concentration of WSO than its produced water source, wherein the “produced water source” is defined herein as the actual produced water that is subjected to the treatment method to form the purified produced water, prior to the subjecting; further wherein concentration of one or more WSO in the produced water source and the purified produced water is suitably determined and/or expressed as a percentage of weight, volume, or weight/volume (w/v) of the produced water source. Thus, in embodiments, a purified produced water includes a concentration of one or more WSO that is 0.1% to 100% lower than the concentration of the one or more WSO in the produced water source by weight, volume, or weight/volume, for example 0.1% to 99%, or 0.1% to 98%, or 0.1% to 95%, or 0.1% to 90%, or 0.1% to 80%, or 0.1% to 70%, or 0.1% to 60%, or 0.1% to 50%, or 0.1% to 40%, or 0.1% to 30%, or 0.1% to 20%, or 0.1% to 10%, or 0.1% to 5%, or 0.1% to 4%, or 0.1% to 3%, or 0.1% to 2%, or 0.1% to 1%, or 0.5% to 100%, or 1% to 100%, or 2% to 100%, or 3% to 100%, or 4% to 100%, or 5% to 100%, or 10% to 100%, or 20% to 100%, or 30% to 100%, or 40% to 100%, or 50% to 100%, or 60% to 100%, or 70% to 100%, or 80% to 100%, or 90% to 100%, or 95% to 100%, or 98% to 100%, or 99% to 100%, or 0.1% to 0.5%, or 0.5% to 1%, or 1% to 5%, or 5% to 10%, or 10% to 15%, or 15% to 20%, or 20% to 25%, or 25% to 30%, or 30% to 40%, or 40% to 50%, or 50% to 60%, or 60% to 70%, or 70% to 80%, or 85% to 90%, or 90% to 95%, or 95% to 96%, or 96% to 97%, or 97% to 98%, or 98% to 99%, or 99% to 100%, or 99% to 99.5%, or 99.5% to 99.8%, or 99.8% to 99.9%, or 99.9% to 100% lower than the concentration of the one or more WSO in the produced water source by weight, volume, or weight/volume.

In embodiments, the methods herein further include regenerating one or more WSO-laden particulates to form one or more regenerated adsorbent particulates. In such context, “regenerating” means desorbing one or more WSO from a WSO-laden particulate. Regenerating an adsorbate-laden particulate is suitably accomplished using one or more conventional methods disclosed in the literature. In many embodiments, the WSO-laden particulate is regenerated by heating, contacting the with one or more solvents, or a serial or contemporaneous combination of heating and contacting with solvent. The heating and/or contacting with solvent causes an amount of one or more WSO adsorbates to desorb from the adsorbent particles, in some embodiments substantially all of the WSO adsorbed by the adsorbent particulate to desorb therefrom, resulting in an amount of one or more desorbed WSO and a regenerated adsorbent particulate. The regenerated adsorbent particulate is suitably collected and re-used as an adsorbent particulate in the methods and compositions described herein, or used in another related or unrelated process. In some embodiments the desorbed WSO are collected, and further refined/purified for use as commercially valuable chemical stock; in other embodiments the desorbed WSO are collected for disposal.

In other embodiments, the methods herein further include collecting a WSO-laden particulate for disposal, optionally further drying and/or compacting the WSO-laden particulate prior to the disposing.

The methods and compositions disclosed herein are easily adapted for use in well completion and production equipment already widely employed in the industry. It is a feature of the compositions and methods disclosed herein that such well production completion string and production string equipment may be modified with case to add or apply one or more adsorbent particulates thereto to form a slurry with a produced water therein; and/or to separate one or more purified produced waters from such a slurry. It is not necessary to redesign or reconfigure any conduits or flow paths already in place in many well completion strings or production strings in order to achieve the results reported herein. Additionally, the amount and type of adsorbent particulate is easily varied within one or more flow paths to address a produced water using a selected adsorbent particulate at a selected addition point within a conduit. Further, the methods described herein are suitably adapted for continuous or batch beneficiation as selected by an operator.

### Experimental Section

Testing of all samples was carried out using the following Bottle Test procedure.

### Bottle Test.

A sample of produced water from a subterranean formation is analyzed via infrared spectrometry to determine the concentration of Petroleum Hydrocarbons (TPH) and Water Soluble Organics (WSO) therein. Then an amount between 100 mL and 140 mL of the produced water is added to a 177 mL glass bottle; and an amount of a selected particulate is added to the bottle to obtain a selected concentration of the particulate in the produced water. The bottle containing the produced water and the particulate is capped and shaken by hand 50 times. Then the contents of the bottle are immediately passed through a folded filter paper having a pore size of approximately 8 micron, and a filtrate is collected.

The filtrate is analyzed for concentration of TPH and WSO using infrared spectrometry. The concentrations of TPH and WSO in the filtrate are “Treated” concentrations. Total Oils and Grease (TOG) in the produced water, defined as the total concentration of hexane-extractable hydrocarbons therein, is the sum of TPH (defined as the fraction of TOG that is extractable by n-hexane but not absorbed on silica) and WSO (defined as the fraction of TOG that is polar, hexane extractable, does not flash off at 85° C., and adsorbs onto silica gel).

### Examples

The percent removal of WSO from three different produced water samples was determined by using the Bottle Test procedure above, and calculating % WSO removed in accordance with the Equation below; results are shown in the Table. The materials added to the produced waters in the Bottle Test included the following:
Activated charcoal: powdered activated charcoal
Dispersion 1:15 wt % dispersion of powdered activated charcoal in water/ethylene glycol mixture
Dispersion 2:15 wt % dispersion of powdered activated charcoal and 0.2 wt % to 0.4 wt % cationic polymer in water/ethylene glycol mixture
Perlite: expanded perlite
Cellulose: cellulose powder filter media

In each of the Examples, TOG, TPH, and WSO for a produced water obtained from a subterranean formation was determined using infrared spectrometry, and the measured concentrations were used as the “Blanks” from which percent removal of WSO was determined in accordance with the Equation below. Three different produced water samples (Blanks 1, 2, and 3) were measured, then used to generate the filtrates in Examples 1, 2, and 3 respectively.

TOG, TPH, and WSO for each filtrate was determined using infrared spectrometry, and the measured concentrations used as the “Treated” values from which the percent removal of WSO was calculated according to the Equation below.

$$\% Removal of WSO = ( {WSO}_{Blank} - {WSO}_{Treated} ) * 100 / {WSO}_{Blank} \qquad Equation$$

TABLE
TOG, TPH, WSO, and % Removal of WSO measured for the filtrates of Examples
1-3, compared to the corresponding produced water (Blanks 1-3). All
listed concentrations and amounts are reported in ppm by weight.

| | | | | | | % |
|---|---|---|---|---|---|---|
| Example | Particulate | Amount, | TOG, | THP, | WSO, | Removal |
| No. | added | ppm | ppm | ppm | ppm | of WSO |
| 1 | NONE | 0 | 108.6 | 9.72 | 98.88 | NA |
| | (Blank 1) | | | | | |
| | Activated | 1000 | 13.78 | 5.26 | 8.52 | 91.38 |
| | charcoal | | | | | |
| | Activated | 2000 | 7.91 | 5.07 | 2.84 | 97.13 |
| | charcoal | | | | | |
| | Activated | 3000 | 5.65 | 5.73 | −0.08 | 100 |
| | charcoal | | | | | |
| 2 | NONE | 0 | 298.8 | 58.15 | 240.65 | NA |
| | (Blank 2) | | | | | |
| | Activated | 100 | 97.57 | 4.57 | 93 | 61.35 |
| | charcoal | | | | | |
| | Activated | 250 | 85.13 | 4.7 | 80.43 | 66.58 |
| | charcoal | | | | | |
| | Activated | 500 | 63.06 | 4.37 | 58.69 | 75.61 |
| | charcoal | | | | | |
| | Activated | 1000 | 21.08 | 1.3 | 19.78 | 91.78 |
| | charcoal | | | | | |
| 3 | NONE | 0 | 245.9 | 12.66 | 233.24 | NA |
| | (Blank 3) | | | | | |
| | Activated | 1000 | 25.74 | 3.42 | 22.32 | 90.43 |
| | charcoal | | | | | |
| | Dispersion 1 | 1000 | 163.9 | 7.71 | 156.19 | 33.03 |
| | Dispersion 2 | 1000 | 177.76 | 6.29 | 171.47 | 26.48 |
| | Dispersion 1 | 5000 | 44.96 | 4.15 | 40.81 | 82.50 |
| | Dispersion 2 | 5000 | 53.69 | 6.79 | 46.9 | 79.89 |
| | Cellulose | 1000 | 129.87 | 3.42 | 126.45 | 45.79 |
| | Perlite | 1000 | 92.85 | 3.38 | 89.47 | 61.64 |
| | 50 wt % | 500/500 | 74.93 | 5.04 | 69.89 | 70.04 |
| | Perlite/50 | | | | | |
| | wt % | | | | | |
| | Cellulose | | | | | |

Inspection of the Table reveals that activated charcoal is highly selective for WSO over THP, and even for very high levels (over 200 ppm) of WSO. 1000 ppm of activated charcoal is sufficient to remove more than 90% by weight of the WSO present in the produced water.

What is claimed is:

1. A method of treating a produced water having one or more water soluble organic compounds (WSO) dispersed therein, the method comprising:
mixing the produced water with 1 ppm to 50,000 ppm by weight of an adsorbent particulate to form a slurry;
applying a flow of the slurry through a conduit; and
separating a purified produced water from the flow of slurry, wherein the purified produced fluid includes a lower concentration of one or more WSO than the produced fluid, wherein WSO is the fraction of the dissolved and dispersed hexane extractable compounds in the produced water that does not flash off at 85° C., and adsorbs onto silica gel.

2. The method of claim 1 wherein the adsorbent particulate has a surface area of 100 m²/g or more, or wherein the adsorbent particulate has a surface area of 1000 m²/g or more.

3. The method of claim 1 wherein the adsorbent particulate has an average particle size of 1 nm to 500 μm.

4. The method of claim 1 wherein the adsorbent particulate is macroporous, microporous, nanoporous, mesoporous, or a combination of two or more thereof.

5. The method of claim 1 wherein the adsorbent particulate comprises one or more of: activated carbon derived from one or more of coconut shell, orange peel, bamboo fiber, rice husk, sewage sludge, or bone; carbon nanotubes; expanded perlite; cellulose; diatomaceous earth; alumina; ultra-high surface area silica; Halloysite nanotubes; or any combination of two or more thereof.

6. The method of claim 1 comprising mixing the produced fluid with 100 ppm to 10,000 ppm by weight of the adsorbent particulate.

7. The method of claim 1 wherein the one or more WSO comprise benzene, toluene, xylene, ethylbenzene, phenols, and/or organic acids.

8. The method of claim 1, further comprising
adding one or more corrosion inhibitors, one or more flocculants, one or more coagulants, one or more scale inhibitors, one or more biocides, or any combination thereof to the produced fluid and/or to the slurry; and/or
adding one or more additional particulates to the produced fluid and/or to the slurry, wherein the one or more additional particulates include an organic polymer comprising a cellulose, a crosslinked dextran, a divinyl benzene-styrene copolymer, or two or more of thereof.

9. The method of claim 1, further comprising adding one or more corrosion inhibitors, one or more biocides, one or more scale inhibitors, or any combination thereof to the purified produced fluid.

10. The method of claim 1 wherein the separating is filtering, and wherein
the filtering is accomplished using a screen, a mesh, a nonwoven or woven thermoplastic mat, a nonwoven or woven metal mat, a paper, a woven or nonwoven fabric mat, a nonwoven or woven glass mat, a frit, a porous membrane, a perforated plate, a felted fabric, or a combination thereof; and/or.
the filtering is microfiltering or ultrafiltering; and/or
the filtering is cross-flow filtering or dead-end filtering.

11. The method of claim 1 wherein the separating comprises applying a central force to the slurry, wherein the central force is applied by a centrifuge or a hydrocyclone.

12. The method of claim 1 wherein the separating comprises sparging the slurry, further wherein the method comprises collecting a froth from the sparged slurry.

13. The method of claim 1 wherein separating is subjecting the slurry to a cross-current flow or to sedimentation.

14. A slurry comprising 1 ppm to 50,000 ppm by weight of an adsorbent particulate dispersed in a produced fluid, the produced fluid having one or more WSO dispersed therein; wherein the slurry is disposed within one or more conduits of a well completion string, a downstream water and/or hydrocarbon treatment, separation, or processing facility, an upstream water and/or hydrocarbon treatment, separation, or processing facility, a hydrogen production facility, an oxidation processing facility, a pyrolysis processing facility, a municipal water treatment facility, an industrial wastewater treatment, separation, or processing facility, or any combination thereof.

15. The slurry of claim 14 wherein the slurry is flowing through the conduit.

16. The slurry of claim 14 wherein the adsorbent particulate has a surface area of 100 m²/g to 1000 m²/g or more; and/or the adsorbent particulate has an average particle size of 1 nm to 500 μm.

17. The slurry of claim 14 wherein the adsorbent particulate comprises one or more of: activated carbon derived from coconut shell, orange peel, bamboo fiber, rice husk, sewage sludge, bone, or two or more thereof; carbon nanotubes; expanded perlite; crosslinked cellulose; diatomaceous earth; alumina; clay; ultra-high surface area silica; Halloysite nanotubes; or any combination thereof.

18. The slurry of claim 14 wherein the slurry comprises 100 ppm to 10,000 ppm by weight of the adsorbent particulate, or wherein the slurry comprises 500 ppm to 5,000 ppm by weight of the absorbent particulate.

19. The slurry of claim 14 wherein the one or more water soluble organic compounds are selected from benzene, toluene, xylene, ethylbenzene, phenols, and organic acids.

20. The slurry of claim 14, further comprising:
one or more corrosion inhibitors, one or more flocculants, one or more coagulants, one or more scale inhibitors, one or more biocides, or any combination thereof; and/or
one or more additional particulates comprising an organic polymer, the organic polymer comprising a cellulose, a crosslinked dextran, a divinyl benzene-styrene copolymer, or any combination thereof.
